(19) United States
(12) Patent Application Publication
(10) Pub. No.: US 2026/0252375 A1
(43) Pub. Date: Aug. 27, 2026

(54) Universal Flash Storage System with Permission Control for Virtual Machine

(71) Applicant: MEDIATEK INC., Hsinchu City (TW)

(72) Inventors: Chin-Chin Cheng, Hsinchu City (TW); Chih-Chieh Chou, Hsinchu City (TW); Liang-Yen Wang, Hsinchu City (TW); Tzu-Shiun Liu, Hsinchu City (TW)

(73) Assignee: MEDIATEK INC., Hsinchu City (TW)

(21) Appl. No.: 19/550,223

(22) Filed: Feb. 25, 2026

Related U.S. Application Data
(60) Provisional application No. 63/763,989, filed on Feb. 27, 2025.

(51) Int. Cl. G06F 9/455

(52) U.S. Cl. CPC G06F 9/45558; G06F 2009/45583

(57) ABSTRACT

UFS system and method of operation are provided. A host runs a plurality of VMs and a hypervisor. A UFS host controller includes a plurality of MCQs, wherein at least one MCQ is allocated to each of the VMs. A first VM initiates a first request with a first identifier, which is communicated directly to the UFS host controller. The UFS host controller determines whether the first request is associated with the at least one MCQ allocated to the first VM based on the first identifier. When the UFS host controller determines that the first request is validly associated with the allocated MCQ, a UFS device performs a first action associated with the first request.

### CROSS REFERENCE TO RELATED APPLICATIONS

This application claims the benefit of U.S. Provisional Application No. 63/763,989, filed on February 27th, 2025. The content of the application is incorporated herein by reference.

### BACKGROUND

### 1. FIELD OF THE INVENTION

The invention relates to access control for UFS host controller registers in a virtualized system, and more particularly to multiple virtual machines sharing a single UFS host controller implementing MCQ and crypto configuration registers.

### 2. DESCRIPTION OF THE PRIOR ART

Universal Flash Storage (UFS) is a flash storage specification designed to provide high data transfer speeds and increased reliability for electronic devices like mobile phones and digital cameras. In modern computing, virtualization allows multiple virtual machines (VMs) to run on a single physical machine, optimizing resource use by ensuring each VM operates independently and remains isolated from others.

Current UFS implementations support a feature called multi-circular queue (MCQ), which allows the system to allocate dedicated hardware resources, such as submission queues (SQ) and completion queues (CQ), to each individual VM. Under existing methods, when a VM needs to access data, it must send its requirements to a hypervisor. The hypervisor then communicates with a UFS driver to issue commands to the host controller hardware. This software-mediated command path typically involves several steps to process a response, which can lead to increased latency.

Furthermore, the UFS Host Controller Interface (HCI) specification often arranges registers related to MCQ and cryptographic (crypto) configurations in a sequential or interleaved manner. For instance, operation registers for different queues may be placed at different base addresses but remain physically interleaved within the hardware. In traditional setups, a hypervisor manages all register access. If the hypervisor incorrectly accesses a control register, such as receiving a request from one VM but accidentally issuing it to the queue of another, it can result in data errors or unexpected information leaks between isolated environments.

### SUMMARY

An embodiment provides a method of operating a universal flash storage (UFS) system. The method comprises running a plurality of virtual machines (VMs) by a hypervisor and allocating at least one multi-circular queue (MCQ) to each of the plurality of VMs. The method further comprises initiating a first request, by a first VM among the plurality of VMs, with a first identifier, wherein the first request is communicated directly to a UFS host controller. Furthermore, the method comprises determining, by the UFS host controller, whether the first request is associated with the at least one MCQ allocated to the first VM based on the first identifier. A UFS device then performs a first action associated with the first request when the UFS host controller determines that the first request is associated with the at least one MCQ allocated to the first VM.

Another embodiment provides a universal flash storage (UFS) system. The UFS system comprises a host, a UFS host controller, and a UFS device. The host is configured to run a plurality of virtual machines (VMs) and a hypervisor. The UFS host controller comprises a plurality of multi-circular queues (MCQs), wherein each of the plurality of VMs is allocated at least one MCQ. The UFS device is configured to perform a first action associated with a first request when the first request, initiated by a first VM among the plurality of VMs, is determined by the UFS host controller to be associated with the at least one MCQ assigned to the first VM.

To the accomplishment of the foregoing and related ends, certain embodiments comprise the features hereinafter fully described and particularly pointed out in the claims. The following description and accompanying drawings set forth in detail certain illustrative aspects of the embodiments. These aspects are indicative, however, of but a few of the various ways in which the principles of the embodiments may be employed, and the present disclosure is intended to include all such aspects and their equivalents. These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 depicts a schematic diagram of a UFS system according to an embodiment.

FIG. 2 depicts a schematic diagram of the UFS system according to another embodiment.

FIG. 3 depicts a flow diagram illustrating a method of operating the UFS system according to an embodiment.

### DETAILED DESCRIPTION

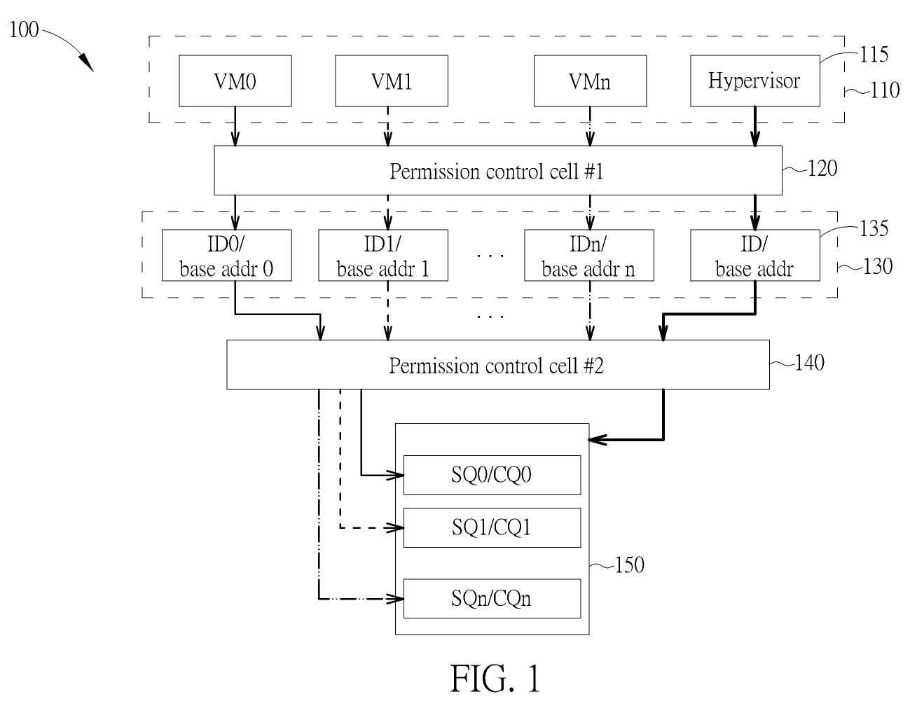

FIG. 1 depicts a schematic diagram of a universal flash storage (UFS) system 100 configured to implement a differentiated permission control mechanism in a virtualized environment according to an embodiment of the present disclosure.

The UFS system 100 may include a host layer 110 comprising a plurality of virtual machines (VMs), such as VM0, VM1, and VMn, and a hypervisor 115. The hypervisor 115 may be configured to perform management functions of a host controller, including reset operations, enable operations, and other global configuration functions.

In some embodiments, the UFS system 100 includes a hardware-based permission control architecture that permits individual virtual machines to access assigned register groups while restricting access to other register groups. The permission control architecture may allow virtual machines to directly access selected registers associated with data transfer operations, without requiring mediation by the hypervisor 115 for each access request.

The permission control architecture may include a first permission control cell 120 and a second permission control cell 140. When an access request is initiated by a virtual machine (e.g., VM0) or by the hypervisor 115, the request may first be received by the first permission control cell 120. The first permission control cell 120 may be configured to determine whether the request is authorized to access a particular base address group or identifier.

The first permission control cell 120 may reference an identification layer 130. The identification layer 130 may include a plurality of identifier entries, each associating a request source with a corresponding base address or identifier. For example, VM0 may be associated with ID0 and/or base address 0, VM1 may be associated with ID1 and/or base address 1, and VMn may be associated with IDn and/or base address n. The associations may be configured by privileged software, such as the hypervisor 115, during system initialization or configuration.

The identification layer 130 may further include a hypervisor identifier 135 associated with the hypervisor 115. The hypervisor identifier 135 may correspond to one or more register groups reserved for global controller management. Access requests bearing the hypervisor identifier 135 may be permitted to access such register groups, while requests associated with VM identifiers are limited to their respective assigned register groups.

Upon validation by the first permission control cell 120, the access request may proceed to the second permission control cell 140. The second permission control cell 140 may be configured to map the validated base address or identifier to a corresponding register group 150. The register group 150 may include, for example, multi-circular queue (MCQ) resources such as submission queue 0 and completion queue 0 (SQ0/CQ0), submission queue 1 and completion queue 1 (SQ1/CQ1), or submission queue n and completion queue n (SQn/CQn).

The second permission control cell 140 may enforce that a request validated for a particular base address or identifier is limited to the associated register group. Accordingly, a request originating from VM0 may be permitted to access registers within the SQ0/CQ0 group and prevented from accessing registers assigned to other virtual machines.

By associating the hypervisor 115 with a hypervisor identifier 135 and associating each virtual machine with a corresponding identifier or base address, the permission control cells 120 and 140 provide hardware-level filtering of access requests. In this manner, management functions performed by the hypervisor 115 may remain distinct from data transfer operations performed by the virtual machines.

In some embodiments, the hardware-level validation performed by the permission control cells 120 and 140 allows virtual machines to access their assigned register groups without requiring the hypervisor 115 to intermediate each data transfer request. This architecture may reduce software-layer processing associated with command routing in a virtualized storage environment.

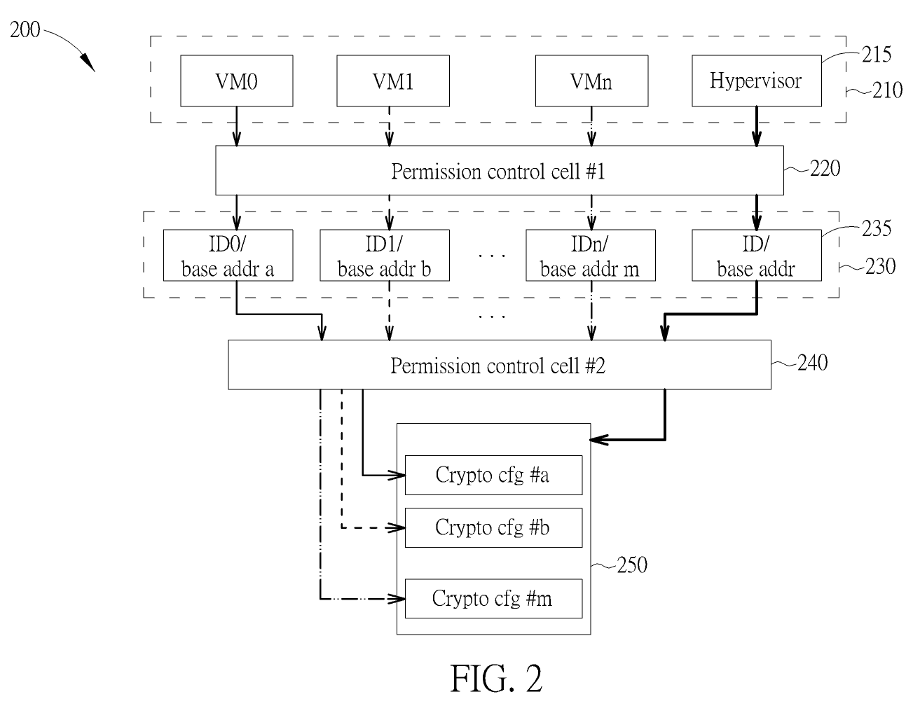

FIG. 2 depicts a schematic diagram of a UFS system 200 implementing a differentiated permission control mechanism applied to cryptographic configuration registers, according to an embodiment of the present disclosure.

Similar to FIG. 1, the UFS system 200 may include a host layer 210 comprising a plurality of virtual machines (VMs), such as VM0, VM1, and VMn, and a hypervisor 215. The hypervisor 215 may be configured to manage global control operations of a UFS host controller, including controller reset, enable, and other management functions.

In the embodiment of FIG. 2, the differentiated permission control mechanism is applied to cryptographic configuration registers defined in a UFS Host Controller Interface (HCI) specification. These cryptographic configuration registers may be arranged sequentially or interleavingly within a register map of the UFS host controller.

The UFS host controller may include a first permission control cell 220 and a second permission control cell 240 configured to enforce hardware-level access validation for the cryptographic configuration registers.

When an access request is initiated by a virtual machine (e.g., VM0) or by the hypervisor 215, the request may first be received by the first permission control cell 220. The first permission control cell 220 may determine whether the request is authorized to access a particular base address group or identifier associated with a cryptographic configuration register group.

The first permission control cell 220 may reference an identification layer 230 that includes a plurality of identifier-to-base-address associations. For example, VM0 may be associated with ID0 and/or base address a; VM1 may be associated with ID1 and/or base address b; VMn may be associated with IDn and/or base address m.

Each base address may correspond to a respective cryptographic configuration register group, such as c rypto cfg #a, c rypto cfg #b, and crypto cfg #m. These cryptographic configuration register groups may define encryption parameters, keys, algorithm selections, or other cryptographic attributes for data transfers associated with the corresponding virtual machine.

In some embodiments, the identification layer 230 further comprises a hypervisor identifier 235 associated with the hypervisor 215. The hypervisor identifier 235 may correspond to one or more cryptographic configuration register groups or controller-level configuration registers reserved for management operations. Access requests bearing the hypervisor identifier 235 may be permitted to access such reserved register groups through the first permission control cell 220 and the second permission control cell 240. In contrast, access requests associated with identifiers assigned to the virtual machines are restricted to their respective allocated cryptographic configuration register groups and are prevented from accessing register groups associated with the hypervisor identifier 235. The hypervisor identifier 235 may be configured during initialization by the hypervisor 215 and enforced by the permission control cells 220 and 240.

Upon validation by the first permission control cell 220, the request may proceed to the second permission control cell 240. The second permission control cell 240 may be configured to map the validated base address or identifier to a corresponding cryptographic configuration register group 250. The second permission control cell 240 may enforce that access is restricted to the specific cryptographic configuration register group associated with the validated identifier.

For example, a request originating from VM0 and validated for base address a may be permitted to access crypto cfg #a and prevented from accessing crypto cfg #b or crypto cfg #m assigned to other virtual machines. In this manner, the permission control mechanism isolates cryptographic configuration resources among multiple virtual machines sharing the same UFS host controller.

In some embodiments, the UFS host controller may support a plurality of cryptographic configuration register groups (e.g., 32, 64, or 128 groups), and the permission control mechanism may allow flexible allocation of one or more cryptographic configuration register groups to each virtual machine. The allocation may be configured during initialization by the hypervisor 215 and enforced in by the permission control cells 220 and 240.

By applying the multi-layer permission filtering mechanism to cryptographic configuration registers arranged within the UFS HCI register map, the system 200 prevents unauthorized access to interleaved cryptographic configuration registers allocated to other virtual machines. As a result, each virtual machine may configure and utilize its assigned cryptographic configuration registers independently, while the hypervisor 215 retains authority over global management functions.

The architecture illustrated in FIG. 2 enables per-VM isolation of cryptographic configuration resources within a shared UFS host controller without requiring hypervisor mediation for each configuration access, thereby reducing software-layer involvement in cryptographic setup operations.

FIGS. 1 and 2 illustrate application of the differentiated permission control mechanism to different classes of registers within the same UFS host controller. Specifically, FIG. 1 depicts isolation of queue-related registers associated with MCQs, including SQ and CQ registers, while FIG. 2 depicts isolation of cryptographic configuration registers defined in the UFS HCI specification. Although the figures separately illustrate queue register groups and cryptographic configuration register groups for clarity, both sets of registers may reside within a common register map of a single UFS host controller and may be sequentially or interleavingly arranged according to the UFS HCI specification. The permission control architecture described herein may be applied to one or more of these register classes within the same controller.

In some embodiments, the differentiated permission control mechanism may be implemented as a unified access validation architecture within a UFS host controller and applied to multiple types of register groups. The first and second permission control cells may operate on an identifier-to-base-address association to enforce per-virtual-machine isolation across different register classes, including queue-related registers (e.g., SQ/CQ registers of allocated MCQs) and cryptographic configuration registers. The permission control mechanism may enforce access restrictions at a register-group level regardless of the specific register function, such that each virtual machine is permitted to access only those register groups allocated to it, while the hypervisor retains access to privileged or global control register groups. Accordingly, FIGS. 1 and 2 represent exemplary applications of a common permission control framework to distinct UFS HCI register categories within the same UFS host controller.

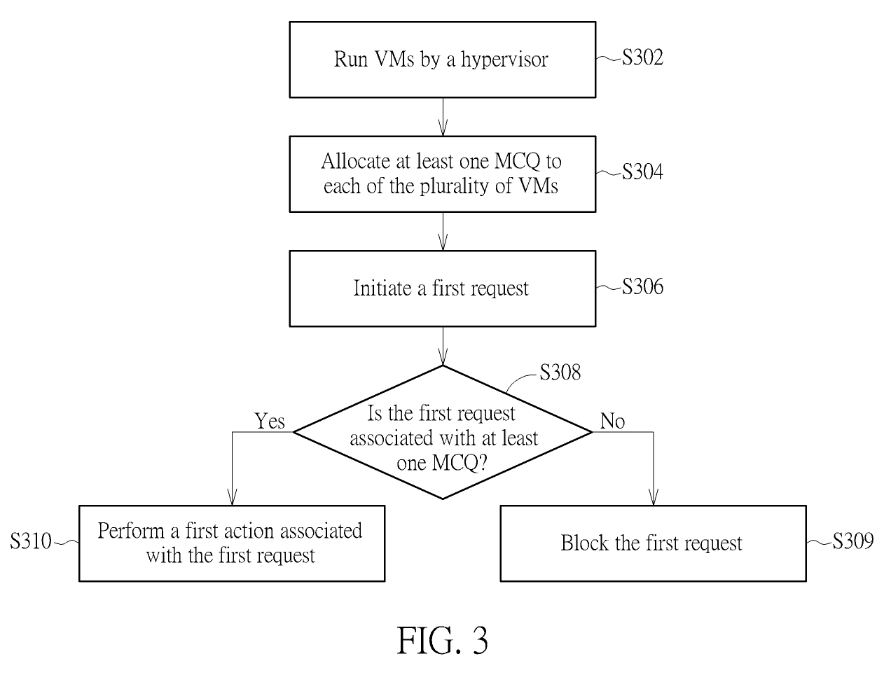

FIG. 3 depicts a flow diagram illustrating a method 300 of operating a UFS system (e.g., UFS system 100 or 200). The method 300 may be performed in a virtualized environment in which multiple virtual machines share a single UFS host controller. The method 300 includes the following steps:

S302: Run a plurality of VMs by a hypervisor;

S304: Allocate at least one MCQ to each of the plurality of VMs;

S306: Initiate a first request;

S308: Determining whether the first request is associated with the at least one MCQ allocated to the first VM based on the first identifier; if so, proceed to S310; if not proceed to S309;

S309: Block the first request; and

S310: Perform a first action associated with the first request.

At step S302, a plurality VMs are executed by a hypervisor. As described in connection with FIGS. 1 and 2, the hypervisor may provide virtualization management functions while the VMs execute operating systems and issue storage-related requests. The hypervisor may retain authority over global controller management operations, including reset, enable, and other host controller configuration functions.

In some embodiments, the UFS system 100 may support a hybrid command routing architecture. While the first VM may communicate the first request directly to the UFS host controller using the hardware permission control cell, the system may also allow for hypervisor-managed routing. For example, a second VM among the plurality of VMs may initiate a second request that is managed by the hypervisor 115. In this scenario, the hypervisor 115 receives the second request from the second VM, processes or translates it, and issues it to the UFS host controller. Subsequently, the UFS device performs a second action associated with the second request.

At step S304, at least one MCQ is allocated to each of the plurality of VMs. In a UFS host controller supporting MCQ functionality, each MCQ may include a SQ and a CQ defined within the UFS HCI register space. Different MCQ register groups (e.g., SQ0/CQ0, SQ1/CQ1, SQn/CQn) may be assigned to different VMs. The allocation may be configured during initialization by the hypervisor and stored in an identification layer, such as identification layer 130 shown in FIG. 1. In some embodiments, the allocation may further include assignment of one or more cryptographic configuration register groups, as illustrated in FIG. 2.

At step S306, a first VM (e.g., VM0) initiates a first request. The first request may correspond to a data read operation, a data write operation, or a configuration access. The first request may include a first identifier, which may comprise a command tag, an initiator identification (IID), a logical unit number (LUN), a base address, or another identifier associated with the first VM.

At step S308, a permission control cell within the UFS host controller determines whether the first request is associated with the at least one MCQ allocated to the first VM based on the first identifier. This determination may include multi-layer validation. For example, a first permission control cell (e.g., element 120 in FIG. 1 or 220 in FIG. 2) may verify whether the first identifier corresponds to a base address group or identifier assigned to the first VM within an identification layer; a second permission control cell (e.g., element 140 in FIG. 1 or 240 in FIG. 2) may map the validated base address or identifier to a specific register group within the UFS HCI register map.

In the embodiment of FIG. 1, the permission control cell may verify that the first request targets the SQ/CQ register group allocated to the first VM and prevent access to interleaved SQ/CQ registers allocated to other VMs. In the embodiment of FIG. 2, the permission control cell may verify that the first request targets a cryptographic configuration register group assigned to the first VM and prevent access to cryptographic configuration registers allocated to other VMs.

At step S309, when the permission control cell determines that the first identifier is not associated with the at least one MCQ allocated to the first VM, the UFS host controller blocks the first request at the level. Blocking may include preventing the request from being written to or propagated through a SQ register, inhibiting access to CQ registers or other associated MCQ registers, and suppressing issuance of any corresponding command to the UFS device. In some embodiments, the UFS host controller may generate an error indication, such as updating a status register, writing an error code to a completion queue associated with the first VM, or issuing an interrupt to the host processor. By blocking unauthorized requests in hardware, the UFS host controller preserves isolation among MCQs allocated to different virtual machines and prevents modification of interleaved registers defined in the UFS HCI.

At step S310, when the permission control cell determines that the first request is associated with the MCQ allocated to the first VM, the UFS device performs a first action associated with the first request. The first action may include, for example, executing a read operation from a LBA, executing a write operation to an LBA, applying a cryptographic operation using a cryptographic configuration register assigned to the first VM, and returning completion information to the CQ associated with the first VM.

In some embodiments, the UFS host controller may assign a first logical block address (LBA) offset to the first request, and apply the first LBA offset to a logical block address of the first request before issuing a physical access to the UFS device, thereby isolating a first storage portion of the UFS device from storage regions assigned to different VMs.

In some embodiments, the method 300 further includes allocation and validation of cryptographic configuration register groups in addition to MCQ register groups. The UFS host controller may allocate, for each virtual machine, at least one cryptographic configuration register group within a cryptographic configuration array defined in the UFS Host Controller Interface (HCI) specification. The allocation may be configured by the hypervisor during initialization and stored in an identification layer accessible to permission control cell.

When a virtual machine initiates a request that involves a data transfer operation subject to cryptographic processing, the request may reference a cryptographic configuration register group assigned to that virtual machine. A permission control cell within the UFS host controller may decode an identifier associated with the request and determine whether the referenced cryptographic configuration register group corresponds to the register group allocated to the initiating virtual machine. The permission determination may be performed using multi-layer validation, including verification of a base address group or identifier mapping and enforcement of register-group-level isolation within the UFS HCI register map.

If the permission control cell determines that the request references a cryptographic configuration register group assigned to a different virtual machine, access may be blocked. If the request is validated, the UFS device may perform a data operation and apply cryptographic processing using the validated cryptographic configuration register group. Accordingly, both queue-related registers, as described with respect to FIG. 1, and cryptographic configuration registers, as described with respect to FIG. 2, may be validated using a unified permission control architecture.

In some embodiments, the method 300 is implemented using dedicated circuits within the UFS host controller. The host may execute multiple virtual machines under control of a hypervisor, while the UFS host controller allocates distinct MCQ register groups to the respective virtual machines and stores allocation information in hardware-accessible configuration registers.

When a virtual machine issues a request, the request may be written into a submission queue register of the allocated MCQ and received by a physical interface of the UFS host controller. A permission control cell, implemented as combinational logic, sequential logic, or other dedicated circuitry within the UFS host controller, may decode an identifier associated with the request and compare the identifier to hardware-stored mappings that associate identifiers with specific register groups defined in the UFS HCI register map.

Based on this comparison, the permission control cell may generate an authorization signal that determines whether the request is permitted to access a targeted register group. If the authorization signal indicates that access is not permitted, the request may be blocked within the controller pipeline. If the authorization signal indicates that access is permitted, the request may be forwarded to execution logic within the UFS host controller and processed by the UFS device. Completion information may be written to a completion queue register corresponding to the initiating virtual machine.

By implementing the above procedures within the UFS host controller, the method modifies the internal operation of the storage controller and enforces per-virtual-machine isolation at the register-map level defined by the UFS HCI specification.

The terminology employed in the description of the various embodiments herein is intended for the purpose of describing particular embodiments and should not be construed as limiting. In the context of this description and the appended claims, the singular forms "a", "an", and "the" are intended to encompass plural forms as well, unless the context clearly indicates otherwise.

It should be understood that the term "and/or" as used herein is intended to encompass any and all possible combinations of one or more of the associated listed items. Furthermore, it should be noted that the terms "includes," "including," "comprises," and/or "comprising," when used in this specification, indicate the presence of stated features, integers, steps, operations, elements, and/or components, but do not exclude the presence or addition of one or more other features, integers, steps, operations, elements, components, and/or groups thereof.

Unless specifically stated otherwise, the term "some" refers to one or more. Various combinations using "at least one of" or "one or more of" followed by a list (e.g., A, B, or C) should be interpreted to include any combination of the listed items, including individual items and multiple items.

In the context of this disclosure, the terms "coupled," "connected," "connecting," "electrically connected," and similar expressions are used interchangeably to broadly denote the state of being electrically or electronically connected. Furthermore, an entity is deemed to be in "communication" with another entity (or entities) when it electrically transmits and/or receives information signals to/from the other entity, irrespective of whether these signals contain image/voice information or data/control information, and regardless of the signal type (analog or digital). It is important to note that this communication can occur through either wired or wireless means. The use of these terms is intended to encompass all forms of electrical or electronic connectivity relevant to the described embodiments.

The use of ordinal designators like "first," "second," and so forth in the specification and claims serves to differentiate between multiple instances of similarly named elements. These designators do not imply any inherent sequence, priority, or chronological order in the manufacturing process or functional relationship between elements. Rather, they are employed solely as a means of uniquely identifying and distinguishing between separate instances of elements that share a common name or description.

The directional terms used in the embodiments such as up, down, left, right, upper-side, down-side, in front of or behind are just the directions referring to the attached figures. Thus, the direction terms used in the present disclosure are for illustration, and are not intended to limit the scope of the present disclosure. It should be noted that the elements which are specifically described or labeled may exist in various forms for those skilled in the art.

As may be used throughout this specification and the appended claims, terms of approximation and degree such as "substantially," "approximately," "generally," "essentially," "nearly," "about," and similar expressions are used to account for variations in precision, manufacturing tolerances, measurement accuracy, environmental conditions, and inherent material properties that may affect the described features or characteristics. Such variations may range from ±20% in broader applications to progressively tighter tolerances of ±10%, ±5%, ±3%, ±2%, ±1%, or ±0.5% in more precise implementations. The specific degree of variation encompassed by these terms of approximation in any given context is informed by the nature of the component, relationship, or parameter being described, the technical requirements of the particular embodiment, and the understanding of one skilled in the relevant art.

The various illustrative components, logic, logical blocks, modules, circuits, operations and algorithm processes described in connection with the embodiments disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus utilized to implement the various illustrative components, logics, logical blocks, modules, and circuits described herein may comprise, without limitation, one or more of the following: a general-purpose single-chip or multi-chip processor, a digital signal processor (DSP), an application specific integrated circuit (ASIC), a field programmable gate array (FPGA), other programmable logic devices (PLDs), discrete gate or transistor logic, discrete hardware components, or any suitable combination thereof. Such hardware and apparatus shall be configured to perform the functions described herein.

A general-purpose processor may include, but is not limited to, a microprocessor, or alternatively, any conventional processor, controller, microcontroller, or state machine. In certain implementations, a processor may be realized as a combination of computing devices. Such combinations may include, for example, a DSP and a microprocessor, a plurality of microprocessors, one or more microprocessors in conjunction with a DSP core, or any other such configuration as may be suitable for the intended application.

It is to be understood that in some embodiments, particular processes, operations, or methods may be executed by circuitry specifically designed for a given function. Such function-specific circuitry may be optimized to enhance performance, efficiency, or other relevant metrics for the particular task at hand. The selection of specific hardware implementation shall be determined based on the particular requirements of the application, which may include, inter alia, performance specifications, power consumption constraints, cost considerations, and size limitations.

In certain aspects, the subject matter described herein may be implemented as software. Specifically, various functions of the disclosed components, or steps of the methods, operations, processes, or algorithms described herein, may be realized as one or more modules within one or more computer programs. These computer programs may comprise non-transitory processor-executable or computer-executable instructions, encoded on one or more tangible processor-readable or computer-readable storage media. Such instructions are configured for execution by, or to control the operation of, data processing apparatus, including the components of the devices described herein. The aforementioned storage media may include, but are not limited to, Random Access Memory (RAM), Read Only Memory (ROM), Electrically Erasable Programmable Read-Only Memory (EEPROM), Compact Disc Read-Only Memory (CD-ROM) or other optical disk storage, magnetic disk storage or other magnetic storage devices, or any other medium capable of storing program code in the form of instructions or data structures. It should be understood that combinations of the above-mentioned storage media are also contemplated within the scope of computer-readable storage media for the purposes of this disclosure.

Some embodiments may involve computers on a distributed computing network, such as a network with multiple clients and/or servers. In such embodiments, clients may run software implementing client-side portions of the described systems and methods, while servers handle requests from these clients. Communication between clients and servers may occur via one or more electronic networks, which may include the Internet, wide area networks, mobile telephone networks, wireless networks (e.g., Wi-Fi, 5G), or local area networks, implemented using any known network protocols.

Various modifications to the embodiments described in this disclosure may be readily apparent to persons having ordinary skill in the art, and the generic principles defined herein may be applied to other embodiments without departing from the spirit or scope of this disclosure. Thus, the claims are not intended to be limited to the embodiments shown herein, but are to be accorded the widest scope consistent with this disclosure, the principles and the novel features disclosed herein.

In certain implementations, the embodiments may comprise the disclosed features and may optionally include additional features not explicitly described herein. Conversely, alternative implementations may be characterized by the substantial or complete absence of non-disclosed elements. For the avoidance of doubt, it should be understood that in some embodiments, non-disclosed elements may be intentionally omitted, either partially or entirely, without departing from the scope of the invention. Such omissions of non-disclosed elements shall not be construed as limiting the breadth of the claimed subject matter, provided that the explicitly disclosed features are present in the embodiment.

Additionally, various features that are described in this specification in the context of separate embodiments also can be implemented in combination in a single implementation. Conversely, various features that are described in the context of a single implementation also can be implemented in multiple embodiments separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

The depiction of operations in a particular sequence in the drawings should not be construed as a requirement for strict adherence to that order in practice, nor should it imply that all illustrated operations must be performed to achieve the desired results. The schematic flow diagrams may represent example processes, but it should be understood that additional, unillustrated operations may be incorporated at various points within the depicted sequence. Such additional operations may occur before, after, simultaneously with, or between any of the illustrated operations.

Additionally, it should be understood that the various figures and component diagrams presented and discussed within this document are provided for illustrative purposes only and are not drawn to scale. These visual representations are intended to facilitate understanding of the described embodiments and should not be construed as precise technical drawings or limiting the scope of the invention to the specific arrangements depicted.

In certain implementations, multitasking and parallel processing may prove advantageous. Furthermore, while various system components are described as separate entities in some embodiments, this separation should not be interpreted as mandatory for all embodiments. It is contemplated that the described program components and systems may be integrated into a single software package or distributed across multiple software packages, as dictated by the specific implementation requirements.

It should be noted that other embodiments, beyond those explicitly described, fall within the scope of the appended claims. The actions specified in the claims may, in some instances, be performed in an order different from that in which they are presented, while still achieving the desired outcomes. This flexibility in execution order is an inherent aspect of the claimed processes and should be considered within the scope of the invention.

The foregoing outlines the features of several embodiments, enabling those skilled in the art to fully appreciate the aspects of the present disclosure. Those skilled in the art should recognize that the present disclosure provides a foundation for designing or modifying other processes and structures to achieve substantially the same functions and/or substantially the same results as those of the embodiments introduced herein. Furthermore, such equivalent arrangements do not deviate from the spirit and scope of the present disclosure, and various changes, substitutions, and alterations may be made without so departing.

What is claimed is:

1. A method of operating a universal flash storage (UFS) system, comprising:
running a plurality of virtual machines (VMs) by a hypervisor;
allocating at least one multi-circular queue (MCQ) to each of the plurality of VMs;
initiating a first request, by a first VM among the plurality of VMs, with a first identifier, wherein the first request is communicated directly to a UFS host controller;
determining, by the UFS host controller, whether the first request is associated with the at least one MCQ allocated to the first VM based on the first identifier; and
performing, by a UFS device, a first action associated with the first request when the UFS host controller determines that the first request is associated with the at least one MCQ allocated to the first VM.

2. The method of claim 1, wherein the at least one MCQ allocated to each VM comprises a submission queue (SQ) and a completion queue (CQ), and wherein each of the plurality of VMs is further allocated at least one crypto configuration register.

3. The method of claim 1, wherein the first identifier is at least one of an initiator identification (IID), a logical unit number (LUN), a tag number, or a base address.

4. The method of claim 1, further comprising:
initiating a second request by a second VM among the plurality of VMs, wherein the second request is managed by the hypervisor; and
performing, by the UFS device, a second action associated with the second request.

5. The method of claim 1, further comprising:
assigning, by the UFS host controller, a first logical block address (LBA) offset to the first request; and
applying the first LBA offset to a logical block address of the first request to isolate a first storage portion of the UFS device from storage portions associated with other VMs.

6. The method of claim 1, wherein determining the association of the first request further comprises:
verifying access authority for a base address group associated with the first VM by a first permission control cell; and
mapping the first request to a specific group of registers within the base address group by a second permission control cell.

7. A universal flash storage (UFS) system, comprising:
a host configured to run a plurality of virtual machines (VMs) and a hypervisor;
a UFS host controller comprising a plurality of multi-circular queues (MCQs), wherein each of the plurality of VMs is allocated at least one MCQ; and
a UFS device configured to perform a first action associated with a first request when the first request, initiated by a first VM among the plurality of VMs, is determined by the UFS host controller to be associated with the at least one MCQ allocated to the first VM.

8. The UFS system of claim 7, wherein the at least one MCQ allocated to each VM comprises a set of registers, wherein the set of registers comprises a submission queue (SQ) register and a completion queue (CQ) register, and wherein each VM is further allocated a crypto configuration register.

9. The UFS system of claim 7, wherein the UFS host controller further comprises:
a first permission control cell configured to determine access permission to a base address or identification group; and
a second permission control cell configured to map the determined access to a specific group of registers.

10. The UFS system of claim 7, wherein:
the hypervisor is configured to manage global controller functions including resets; and
the first VM is configured to directly access the UFS device for data transfer operations using the at least one MCQ allocated to the first VM.

11. The UFS system of claim 7, wherein the UFS host controller is further configured to:
assign a first logical block address (LBA) offset to the first request; and
apply the first LBA offset to a logical block address of the first request to isolate a first storage portion of the UFS device from storage portions associated with other VMs.

12. The UFS system of claim 7, wherein the UFS host controller is further configured to isolate registers that are sequentially or interleavingly arranged in a UFS Host Controller Interface (HCI) specification.

13. The UFS system of claim 7, wherein the plurality of MCQs comprise a first set of submission and completion queues assigned to the first VM and a second set of submission and completion queues assigned to a second VM among the plurality of VMs.

14. The UFS system of claim 7, wherein the UFS host controller further comprises a permission control cell configured to support a variable number of crypto configuration registers for each VM.
